(19) United States
(12) Patent Application Publication
(10) Pub. No.: US 2026/0253022 A1
(43) Pub. Date: Aug. 27, 2026

(54) DELIVERY PLANNING APPARATUS, DELIVERY PLANNING METHOD, AND PROGRAM

(71) Applicant: NTT, Inc., Tokyo (JP)

(72) Inventors: Zhao WANG, Tokyo (JP); Yusuke NAKANO, Tokyo (JP); Daisuke KIKUTA, Tokyo (JP)

(21) Appl. No.: 19/162,252

(22) PCT Filed: Mar. 10, 2023
(86) PCT No.: PCT/JP2023/009419

§ 371 Date: Sep. 4, 2025

(51) Int. Cl. G06Q 10/083

(52) U.S. Cl. CPC G06Q 10/08355

(57) ABSTRACT

A delivery planning device includes an algorithm calculation unit that has a model of a neural network that determines a route for a moving body on which a delivery target used for replenishment of an inventory is loaded to travel around a plurality of nodes to replenish an inventory. The algorithm calculation unit inputs features of a moving body including a moving speed and a maximum load amount and features of a node including an inventory consumption speed and a maximum inventory capacity to the model.

### TECHNICAL FIELD

The present invention relates to a technique of creating a delivery route when a vehicle travels around a plurality of customers and delivers baggage.

### BACKGROUND ART

A problem of creating an optimal delivery route (delivery tour) when a vehicle carrying baggage travels around a plurality of customers to replenish an inventory at each customer is referred to as a CIRP (Continuous Time Inventory Routing Problem).

A CIRP requires the generation of an optimal delivery route for replenishing the inventory of customers while ensuring that the inventory level of a customer exceeds a certain threshold value. The amount of baggage that can be delivered (unloaded) to the location of a customer is limited according to the inventory capacity of the customer and the load amount of a delivery vehicle. At the same time, customer demand decreases continuously. Note that, in the following description, unloading baggage to a customer may be referred to as “drop-off”.

The object of optimization in a CIRP is to minimize the cumulative delivery cost (tour cost) while ensuring that the remaining inventory level of each customer exceeds a certain level such as 0.

In general, a CIRP is a typical NP-hard problem of combinatorial optimization problems. For example, in a case where there is one vehicle and n customers (nodes), and all candidate solutions are listed, it is necessary to search the n! patterns in order to obtain the correct solution. That is, solving a CIRP is a task that makes it difficult to calculate a reliable solution with a reasonable processing time.

### CITATION LIST

### Non Patent Literature

Non Patent Literature 1: Lagos, F. et al., “The continuous-time inventory-routing problem.” Transportation Science, 54(2), 375-399, 2020

### SUMMARY OF INVENTION

### Technical Problem

For example, Non Patent Literature 1 discloses the prior art of generating an optimal solution of a CIRP by using integer programming. However, in the prior art, even a simple problem setup can take several days to calculate a solution. In addition, in the prior art, it is not possible to consider a dynamic decrease in inventory under conditions of different types of vehicle settings (load capacity different for each vehicle and the like).

That is, in the prior art, it is difficult to quickly create an appropriate delivery route for the vehicle to travel around a plurality of customers and replenish an inventory.

The present invention has been made in view of the above points, and an object of the present invention is to provide a technique capable of quickly creating an appropriate delivery route for a vehicle to travel around a plurality of customers and replenish an inventory.

### Solution to Problem

According to the disclosed technique, there is provided a delivery planning device including:
an algorithm calculation unit that has a model of a neural network that determines a route for a moving body on which a delivery target used for replenishment of an inventory is loaded to travel around a plurality of nodes to replenish an inventory, in which
the algorithm calculation unit inputs features of a moving body including a moving speed and a maximum load amount and features of a node including an inventory consumption speed and a maximum inventory capacity to the model.

### Advantageous Effects of Invention

According to the disclosed technique, there is provided a technique capable of quickly creating an appropriate delivery route for a vehicle to travel around a plurality of customers to replenish an inventory.

### BRIEF DESCRIPTION OF DRAWINGS

FIG. 1 is a diagram illustrating an image of baggage delivery.

FIG. 2 is a configuration diagram of a delivery planning device 100.

FIG. 3 is a configuration diagram of an algorithm calculation unit 130.

FIG. 4 is a diagram illustrating variables/features.

FIG. 5 is a diagram illustrating a decoder and an encoder.

FIG. 6 is a diagram illustrating a hardware configuration example of the device.

### DESCRIPTION OF EMBODIMENTS

Hereinafter, an embodiment of the present invention (the present embodiment) will be described with reference to the drawings. The embodiment to be described below is merely an example, and embodiments to which the present invention is applied are not limited to the following embodiment.

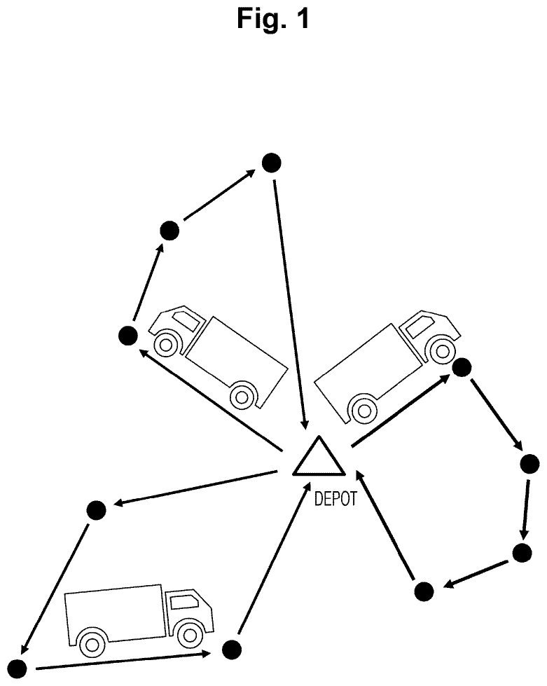

In the present embodiment, in a CIRP, a vehicle (delivery vehicle) moves and carries baggage to a node (customer). FIG. 1 illustrates an image thereof. In FIG. 1, a black circle is a node, and a triangle is a depot (distribution base). However, this is an example. The subject carrying the baggage may be a person or something other than a vehicle or a person. The subject carrying the baggage may be collectively referred to as a “moving body”. That is, “vehicle” in the following description may be replaced with “moving body”.

In addition, what is carried (provided to the customer) is not limited to an article, and may be, for example, electric power. In addition, in the present embodiment, for convenience, a subject having an inventory is referred to as a “customer”. The “customer” is, for example, a building or a warehouse.

### (Premise of Embodiment)

In the present embodiment, in the implementation of a CIRP in a delivery planning device 100 which will be described later, simplification is performed to facilitate calculation. However, such simplification is an example, and simplification may not be performed.

In the simplification, first, both a time required for drop-off and a time required for pickup are “instantaneous” (that does not take time). That is, when a vehicle arrives at a customer or a depot (distribution base), the vehicle can immediately move to the next destination.

Second, the customer demand is constant. Ignoring the possibility that there is a peak time in demand, it is simply assumed that the inventory of the customer decreases linearly.

Third, there is no partial delivery. That is, in all drop-offs, the baggage of a vehicle is completely emptied or the inventory of the customer is made full.

Fourth, it is assumed that the waiting time is discrete. In a case where the vehicle determines not to move, that is, to stay at the current location, the only option is to stay for a designated (prescribed) discrete time. The vehicle can choose to stay again for the subsequent action. Finally, meeting customer inventory demands is relaxed to soft constraints.

### (Application Example)

In an actual application, there are many practical business scenarios in which distribution and service costs can be optimized through a solution of a CIRP, such as route generation of an e-commerce drone, just-in-time delivery of e-commerce, cold-chain delivery, store replenishment, and the like.

For example, as one of the fields to which the technique according to the present embodiment is applied, there is a case where a charging tour of a power supply vehicle that supplies electric power to a telecommunication exchange building (TE building) is generated in a disaster response system.

In general, from past disaster response experiences, the largest cause of failure of telecommunications services is due to exhaustion of batteries installed in TE buildings due to extensive and prolonged power outages. As described above, an optimized charging tour capable of minimizing the cumulative moving cost while keeping the remaining battery level in each TE building equal to or higher than a certain threshold value is one of application fields of the technique according to the present embodiment. In this case, the baggage corresponds to electric power, the TE building corresponds to a customer, and the remaining battery level corresponds to an inventory. In addition, a base that supplies electric power to the power supply vehicle serves as a depot.

### (Problems)

The following problems can be solved by the technique according to the present embodiment with respect to the prior art such as Non Patent Literature 1.

Handling of different types of vehicle settings (different settings between vehicles): Depending on the requirements of CIPR, differences in load capacity, moving speed, and the like between vehicles are considered.

Handling of asynchronous operation patterns of a plurality of vehicles: Unlike a general multi-agent environment in which all agents (vehicles) operate simultaneously or alternately, in CIPR in the present embodiment, a moving time of each vehicle is different from that of other vehicles depending on the current destination position, and thus the vehicles operate asynchronously (select a customer of the destination). For example, the vehicle A selects a customer M as a destination and travels a long distance toward the customer M. On the other hand, since the moving cost between N, O, and P is not so large, the vehicle B visits the three customers N, O, and P to replenish the inventory of these customers.

Handling of differences in inventory feature between customers: The linear decrease rate of inventory varies for each customer, and the maximum inventory capacity also varies for each customer.

Object of optimization: The object is to minimize the cumulative delivery cost (cumulative tour cost) while ensuring that the remaining inventory level (inventory quantity) of each customer exceeds a certain level such as 0.

Obtaining a robust optimization result with a high-speed execution time: Unlike the prior art that requires several days to several months to search and find solutions, advanced algorithms such as deep learning can be used to train robust policies offline and solutions can be quickly determined online for various complex situations of CIPR. Note that the training may be continuously performed online.

### (Device Configuration Example)

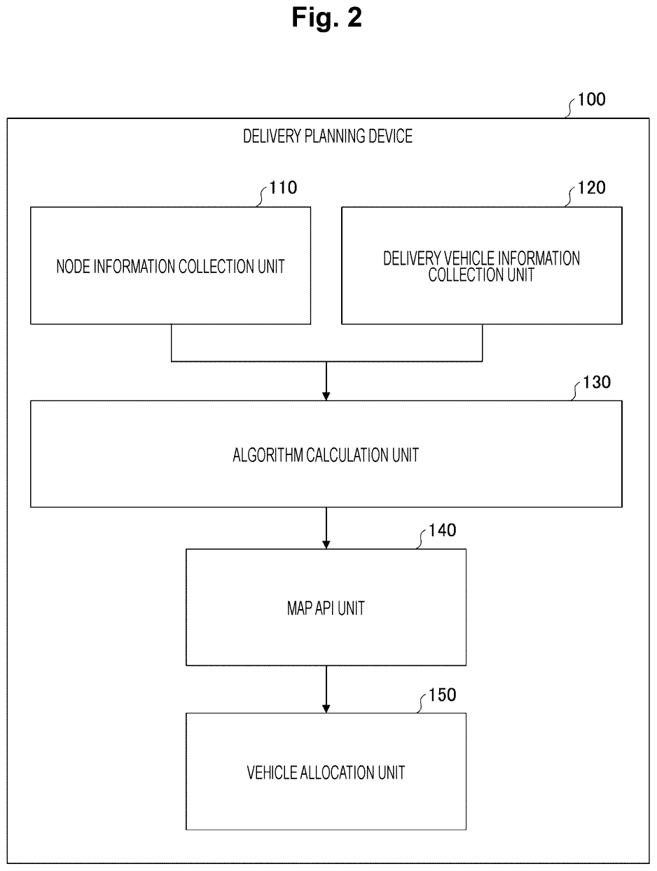

FIG. 2 illustrates a configuration diagram of the delivery planning device 100 according to the present embodiment. As illustrated in FIG. 2, the delivery planning device 100 includes a node information collection unit 110, a delivery vehicle information collection unit 120, an algorithm calculation unit 130, a map API unit 140, and a vehicle allocation unit 150.

The delivery planning device 100 may be implemented by one device (computer) or may be implemented by a plurality of devices. For example, the algorithm calculation unit 130 may be implemented in a certain computer, and other functional units may be implemented in another computer. An operation outline of the delivery planning device 100 is as follows.

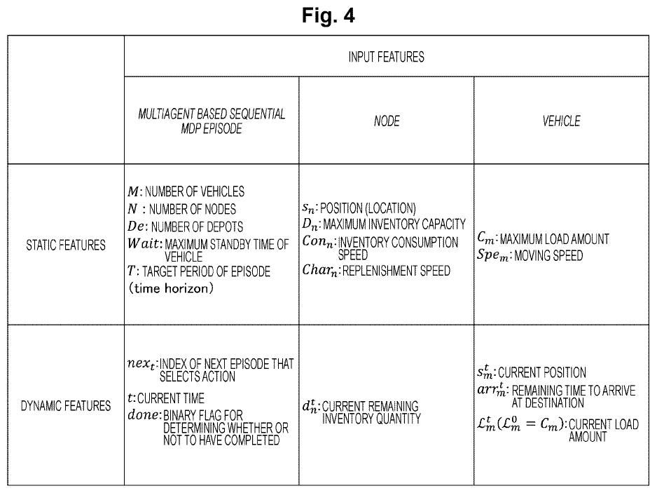

The node information collection unit 110 acquires a feature of each node (customer). The feature of each node includes, for example, a position of the node, information regarding an inventory, and the like. More specifically, the node information collection unit 110 acquires the static features of the node in FIG. 4. The acquisition destination may be each node, a server in which information of each node is accumulated, or the like.

The delivery vehicle information collection unit 120 collects a feature of each vehicle. Specifically, the delivery vehicle information collection unit 120 acquires the static feature of the vehicle in FIG. 4. The acquisition destination may be each vehicle, a server in which information of each vehicle is accumulated, or the like.

The algorithm calculation unit 130 outputs the delivery planning by solving a CIRP based on the information of each node (customer) and each vehicle. Details of the algorithm calculation unit 130 will be described later. The delivery planning here is, for example, information indicating the order of nodes traveling around (a column in which nodes are arranged in order) for each vehicle.

The map API unit 140 performs a route search based on the information of the delivery planning output from the algorithm calculation unit 130, and plots the route of the delivery planning of each vehicle on the map, for example. Based on the output result of the map API unit 140, the vehicle allocation unit 150 distributes the service route information to each vehicle (alternatively, the terminal of the service center) via the network. In addition, the vehicle allocation unit 150 may be referred to as an “output unit”.

The map API unit 140 may perform route search or the like by accessing, for example, an external map server. In addition, the map API unit 140 itself may store a map database and perform route search by using the map database.

As an example, it is assumed that, as a delivery planning, a delivery planning of “0→2→3→0” is obtained by the algorithm calculation unit 130 for a certain vehicle. Here, 0 indicates a node of the depot (distribution base), and 2 and 3 each indicate a number of a node corresponding to a customer. In this case, the map API unit 140 plots an actual road route of “depot→customer 2→customer 3→depot” on a map, and the vehicle allocation unit 150 outputs the plotted map information of the route.

### (Configuration Example of Algorithm Calculation Unit 130)

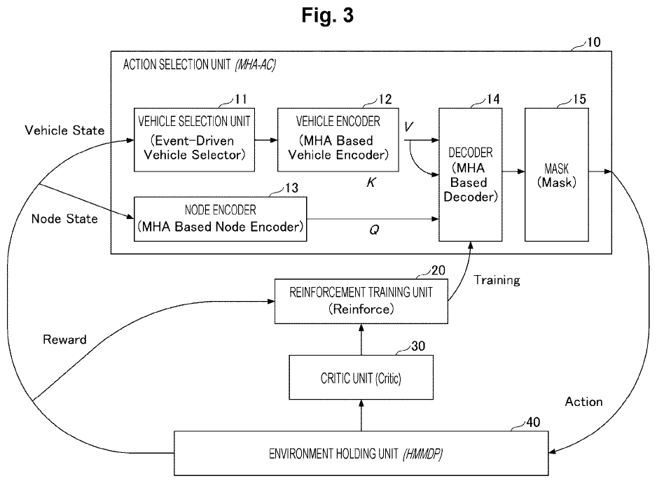

FIG. 3 illustrates a configuration example of the algorithm calculation unit 130. The algorithm calculation unit 130 is a model of a neural network that performs reinforcement training of the Actor-Critic method. However, in the present embodiment, the training method is not limited to using reinforcement training. In FIG. 3, another name of each component is described in English.

As illustrated in FIG. 3, the algorithm calculation unit 130 includes an action selection unit 10 (MHA-AC), a reinforcement training unit 20 (Reinforce), a critic unit 30 (Critic), and an environment holding unit 40 (HMMDP). The environment holding unit 40 (HMMDP) may be referred to as an environment.

The action selection unit 10 (MHA-AC) includes a vehicle selection unit 11 (Event-Driven Vehicle Selector), a vehicle encoder 12 (MHA Based Vehicle Encoder), a node encoder 13 (MHA Based Node Encoder), a decoder 14 (MHA Based Decoder), and a mask 15 (Mask). An operation outline is as follows.

The action selection unit 10 (MHA-AC) receives the state of the vehicle and the state of the node as inputs from the environment holding unit 40 (HMMDP) at each time step, and selects an action (action) which is a node that the vehicle visits next. The selected action is output to, for example, the map API unit 140 and input to the environment holding unit 40 (HMMDP).

The environment holding unit 40 (HMMDP) receives the action as an input, updates the entire state based on the action, and outputs a reward, an updated state of the vehicle, and an updated state of the node for each time step. The policy (parameter) of the action selection unit 10 (MHA-AC) is automatically trained by reinforcement training using, for example, an actor critic.

In the reinforcement training, a reward (Reward) calculated by the environment holding unit 40 (HMMDP) is input to the reinforcement training unit 20, and a calculation result of a value evaluation function (a value indicating how good a policy is) is input from the critic unit 30 (Critic) to the reinforcement training unit 20. The reinforcement training unit 20 updates the weight parameter of the action selection unit 10 and the weight parameter of the critic unit 30 based on these inputs.

The environment holding unit 40 (HMMDP) in the present embodiment configures a heterogeneous multiagent based Markov decision process environment (HMMDP) to completely satisfy the requirements of a CIRP, such as different types of vehicle settings and a multiagent asynchronous action pattern. In addition, the action selection unit 10 (MHA-AC) in the present embodiment has a configuration to execute an end-to-end multi-head attention and actor critic based algorithm (MHA-AC) for automatically solving a CIRP.

The action selection unit 10 (MHA-AC) and the environment holding unit 40 (HMMDP) will be described below in more detail.

### (Environment Holding Unit 40 (HMMDP))

First, the environment holding unit 40 will be described. FIG. 4 illustrates a table summarizing variables/features used in the following description.

### <Regarding Problem Setting of Environment Holding Unit 40 (HMMDP)>

The problem setting of a CIRP in the present embodiment is formulated as a problem of determining an optimal route for the vehicle to travel around a given set of nodes defined on the undirected graph G=(V, E).

Here, V={V₀, V₁, . . . , Vₙ, . . . , V_{N-1}} is a set of nodes. E={(e_{i, . . . , j}) |i, j∈V} is a set of edges and indicates a moving cost between Vᵢ and Vⱼ. The moving cost may be, for example, a moving distance or a moving time.

The node V₀ is a depot at which each agent (each vehicle) starts a tour in a case where there is only one depot. Note that, in a case where two depots are used in the problem setting, the first two nodes V₀ and Vᵢ are the depots.

On the other hand, considering the fleet X={X₀, X₁, . . . , Xₘ, . . . , Xₘ₋₁} of vehicles with a centralized policy parameterized by θ, π is set as the centralized policy of all vehicles. For each vehicle Xₘ, Lₘ^{t} (Lₘ⁰=Cₘ) represents the remaining load amount (current load amount) of the vehicle Xₘ, and, when the vehicle Xₘ visits each node, the remaining load amount is obtained by subtracting the demand from the vehicle maximum load amount C.

At a time t during the tour, when Lₘ^{t} becomes 0 or becomes a value as small as cannot be replenished at any node in the set V, the vehicle Xₘ forcibly returns to the depot, and the load amount becomes Lₘ^{t+t′}. t′ is a time at which the vehicle Xₘ needs to return to the depot.

The goal in the present embodiment is to find an optimal stochastic centralized policy π* that can create a replenishment tour Y^{T}={y⁰, y¹, . . . y^{τ}, . . . y^{T-1}} of the inventory for all vehicles.

### <Multiagent Based Sequential MDP>

The environment holding unit 40 (HMMDP) is defined by a tuple (X, T, S, A, P, P₀, R). More specifically, the environment holding unit 40 (HMMDP) holds a tuple (X, T, S, A, P, P₀, R). Each element constituting the tuple is as follows. Note that an “episode” in the following description refers to a period from the start to the end of a task intended to be solved by reinforcement training. The episode is constituted by a plurality of time steps.

X={X₀, X₁, . . . , Xₘ, . . . , Xₘ₋₁} is a set of vehicles that interact with the environment holding unit 40 (HMMDP). For each Xₘ∈X, as illustrated in FIG. 4, Xₘ=(Cₘ, Speₘ, Sₘ^{t}, arrₘ^{t}, Lₘ^{t}) is defined. Cₘ and Speₘ are two static features indicating the maximum load amount and the moving speed of the vehicle. On the other hand, sₘ^{t}, arrₘ^{t}, and Lₘ^{t} are dynamic features representing the current position of Xₘ, the remaining time to arrive at the next node of Xₘ, and the current load amount of Xₘ, respectively, and change during the episode.

T={t₀, t₁, . . . , t_{τ}, . . . , t_{T-1}} is a period (time interval) (time horizon) of an optimization process. All episodes end at the finite step t_{T-1}. Each t_{τ}∈T is a timing at which an action occurs. The number of elements of T is variable for each episode.

S is a global state having individual states Sₜ for each vehicle Xₘ=(Cₘ, Speₘ, sₘ^{t}, arrₘ^{t}, Lₘ^{t}) and the combined environmental state sₜ^{env}=(dₙ^{t}, nexₜ, skipₜ) as elements.

Where dₙ^{t} is the current remaining inventory of a node n. nexₜ indicates the agent (vehicle) that acts next in each episode.

The individual action aₜ^{m}∈A is an action for selecting whether the m-th vehicle moves to the next node, returns to the depot, or stands by without doing anything. As described above, in the problem setting in the present embodiment, the vehicles (vehicle group) do not operate synchronously or alternately. Thus, at each t_{τ}, it is necessary to determine which vehicle (nexₜ) arrives at the destination next and to process the arrival. A detailed calculation method of nexₜ will be described later.

P is a transition function. The transition function is defined as follows.

$$\begin{matrix}[ Math . 1 ] & \\ P ( {s}_{t + 1} , {a}_{t + 1}^{{nex}_{t}} \vert {s}_{t} , {a}_{t}^{m} , {nex}_{t} ) & \end{matrix}$$

This transition function is defined as a probability that the vehicle m takes the action aₜ^{m} in the state sₜ, and then the vehicle nexₜ determines the action represented by the following term to reach the state of sₜ₊₁.

$$\begin{matrix}[ Math . 2 ] & \\ {a}_{t + 1}^{{nex}_{t}} & \end{matrix}$$

The initial state P₀ (s₀, a₀) prescribes an agent (vehicle) that acts first. In the present embodiment, which vehicle departs first is freely selected.

$$\begin{matrix}[ Math . 3 ] & \\ P ( {s}_{t + 1} , {a}_{t + 1}^{n e {x}_{t}} \vert {s}_{t} , {a}_{t}^{m} , ne {x}_{t} ) & \end{matrix}$$

is calculated by the neural network model in the present embodiment.

A reward function R is defined as follows.

$$\begin{matrix}[ Math . 4 ] & \\ R = \frac{{\sum }_{τ = 0}^{T - 1} {H}_{τ}}{N * T} + P \cdot {\sum }_{τ = 0}^{T - 1} {e}_{{y}^{τ} , {y}^{τ + 1}} & ( 1 )\end{matrix}$$

The reward function R shown in Expression (1) includes two parts described below. The first term is a penalty term.

$$\begin{matrix}[ Math . 5 ] & \\ \frac{{\sum }_{τ = 0}^{T - 1} {H}_{τ}}{N * T} & \end{matrix}$$

is the proportion of nodes having an empty inventory, which is accumulated in the entire time horizon T, and H, is the number of empty inventories. The second term is the moving cost in the replenishment tour Y^{T}. The purpose of the reward function is to minimize the cumulative tour cost while meeting the constraint that the remaining inventory level of each customer exceeds 0.

### (Action Selection Unit 10 (MHA-AC))

Next, each unit constituting the action selection unit 10 (MHA-AC) will be described.

### <Vehicle Selection Unit 11 (Event-Driven Vehicle Selector)>

First, the vehicle selection unit 11 will be described. As described above, the problem setting in the present embodiment is different from that in the prior art related to many multi-agents. Therefore, in the present embodiment, it is necessary to determine which vehicle (agent) arrives at the destination next at each t∈T. To integrate this characteristic into the model, an additional variable nexₜ∈X indicating which agent (vehicle) needs to make the determination at the current t is added to the state. nexₜ depends on the time arrₘ^{t} taken to move to the selected customer and is defined by the following Expressions (2) and (3).

$$\begin{matrix}[ Math . 6 ] & \\ n e {x}_{t} = arg min \{ a r {r}_{m}^{t} : for all m ∈ X \} & ( 2 )\end{matrix}$$

$$ar {r}_{m}^{t} = \{ ( {e}_{{m}^{t} , j} ) \vert j ϵ V \} \qquad ( 3 )$$

The vehicle selection unit 11 in the present embodiment sets the vehicle index with the minimum arrₘ^{t} as nexₜ. arrₘ^{t} is a set of moving costs from the current position of the vehicle m to all the nodes j∈V including the customer and the depot.

### <Vehicle Encoder 12/Node Encoder 13>

In the present embodiment, a centralized multi-head attention based model that selects an action (node index) of each vehicle in time series is used. The model according to the present embodiment includes two independent multi-head attention encoders, which are referred to as a node encoder 13 and a vehicle encoder 12, and transfer information directly to the respective feedforward layers.

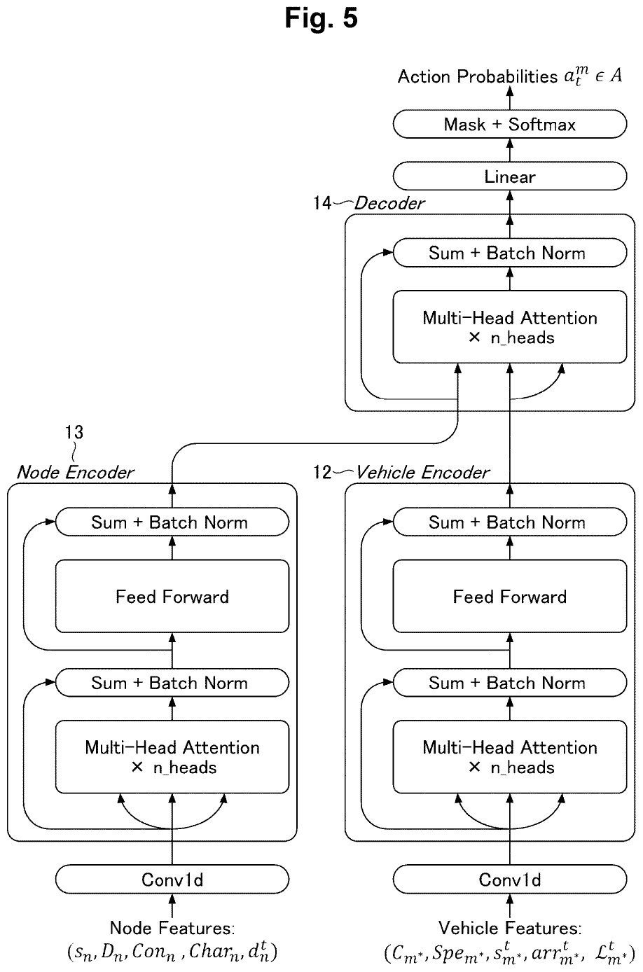

FIG. 5 illustrates a specific configuration example of the vehicle encoder 12, the node encoder 13, and a decoder 14.

As illustrated in FIG. 5, the outputs of the node encoder 13 and the vehicle encoder 12 are transferred to the decoder 14, which is a third multi-head attention block.

The node encoder 13 uses the node features (sₙ, Dₙ, Conₙ, Charₙ, dₙ^{t}) of each node as an input, as a single concatenation tensor.

In the node encoder 13, after projecting the input in 128 dimensions by Conv1D, this tensor is transferred as query, key, value to self-multi-head attention. Thereafter, normalization is performed on the output of the self-multi-head attention and the like, and the output passes through the feedforward layer. However, unlike the encoder of a transformer that encodes the node only once, in the node encoder 13 in the present embodiment, the dynamic state dₙ^{t} changes for each step t, so that it is used for each determination step t.

On the other hand, the vehicle encoder 12 determines the relationship between each vehicle and all the other vehicles. At each t, the following features of the vehicle selected by the vehicle selection unit 11 are input to the vehicle encoder 12, with episodic features T and t as one concatenation tensor.

$$\begin{matrix}[ Math . 7 ] & \\ ( {C}_{{m}^{*}} , {Spe}_{{m}^{*} ,} {s}_{{m}^{*}}^{t} , {arr}_{{m}^{*}}^{t} , {ℒ}_{{m}^{*}}^{t} ) & \end{matrix}$$

This tensor is also transferred as query, key, value to the multi-head attention, and then, normalization is performed. The output passes through the feedforward layer.

The node encoder 13 and the vehicle encoder 12 have the multi-head attention having the same configuration, but have different weights to be initialized. Note that the multi-head attention based encoder itself is an existing technique.

### <Decoder 14, Mask 15>

The decoder 14 uses the outputs of the two encoders 12 and 13 placed before the decoder 14 to determine the probability of each action. The third multi-head attention block in the decoder 14 inputs the output of the node encoder 13 as a query, and inputs the output of the vehicle encoder 12 as a key-value pair. The decoder 14 outputs the probability of the action by using these inputs. For example, an action having the highest probability is selected by the action selection unit 10 through the following mask. Note that the multi-head attention based decoder itself is also an existing technique.

After it is determined which vehicle will arrive at the destination next and the arrival has been processed by the decoder 14, when the environment is “up-to-date” and ready for the next action, the mask 15 is generated.

The mask 15 holds a binary value for each node n and is generated for the vehicle m. More specifically, the mask 15 is defined as follows.

$$\begin{matrix}[ Math . 8 ] & \\ {mask}_{n}^{m} = \{ \begin{matrix}0 , & if ( {K}_{1} or {K}_{2} or {K}_{3} ) or ( skip ) \\ 1 , & otherwise\end{matrix} & ( 4 )\end{matrix}$$

$$for n = 0 to N - 1$$

In the above Expression (4), K₁ and K₂ are conditions in a case where the node is a customer or a depot, respectively, and K₃ is a condition for confirming whether or not there is sufficient time for the vehicle to visit the node n and return to the nearest depot, and is represented as follows.

$${K}_{3} = α + β > T - t \qquad ( 5 )$$

In the above Expression (5), α is the movement time from the position of the agent (vehicle) to the node n, and β is the movement time from the node n to the closest depot. T-t is the time remaining in the episode.

The mask 15 fills the position of the node n with 0 to limit selection of the node n by the agent (vehicle) (that is, the node n is not selected). Note that the action of the mask 15 varies depending on whether or not the episode is skipped.

In Expression (4), if the episode is not skipped, K₁, K₂, or K₃ is evaluated. K₁ is considered in a case where the node n is a customer. The mask 15 (maskₙ^{m}) is filled with 0 when the load amount of the vehicle is 0. This is because there is no reason why a vehicle with nothing loaded travels to the customer.

K₂ is considered in a case where the node n is a depot. Since there is no reason for a vehicle at the depot to go to another depot, in a case where the current location of the vehicle is another depot that is not the node n, the mask of the node n is filled with 0.

K₃ is considered for all nodes. In a case where the calculation using α and β does not allow the vehicle to go to node n and return to the depot before T, the mask 15 (maskₙ^{m}) is filled with 0. Thus, the vehicle can reliably return to the depot at the end of the episode. In a case where the episode is skipped, all nodes n that are not at the current position are filled with 0.

### <Reinforcement Training>

A reward (Reward) calculated by the environment holding unit 40 (HMMDP) is input to the reinforcement training unit 20, and a calculation result of a value evaluation function is input from the critic unit 30 (Critic) to the reinforcement training unit 20. The reinforcement training unit 20 updates the weight parameter of the action selection unit 10 and the weight parameter of the critic unit 30 based on these inputs.

In the present embodiment, parameters are trained according to stochastic gradient descent (SGD) by using a reinforcement training method referred to as Actor-Critic. For example, the parameter is updated by using the SGD of the mean prediction error on a trajectory (trajectory) sample.

The weight update procedure itself in Actor-Critic reinforcement training is an existing technique. For example, a procedure disclosed in the document “Nazari, Mohammadreza, Afshin Oroojlooy, Lawrence V. Snyder, and Martin Takac, “Reinforcement Learning for Solving the Vehicle Routing Problem”, NIPS, 2018.” can be used.

### (Hardware Configuration Example)

The delivery planning device 100 can be realized, for example, by causing a computer to execute a program. This computer may be a physical computer or may be a virtual machine on a cloud.

That is, the delivery planning device 100 can be implemented by executing a program corresponding to processing performed by the delivery planning device using hardware resources such as a CPU and a memory built in the computer. The above program can be stored and distributed by being recorded in a computer-readable recording medium (portable memory or the like). Furthermore, the above program can also be provided through a network such as the Internet or an electronic mail.

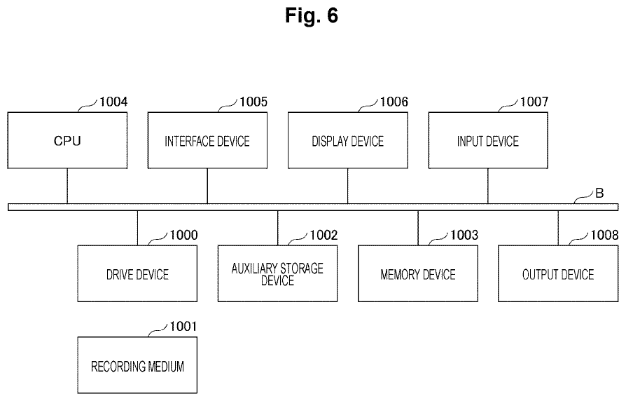

FIG. 6 is a diagram illustrating a hardware configuration example of the computer. The computer in FIG. 6 includes a drive device 1000, an auxiliary storage device 1002, a memory device 1003, a CPU 1004, an interface device 1005, a display device 1006, an input device 1007, and an output device 1008, which are connected to one another by a bus BS.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002 and stores the program. The CPU 1004 realizes a function related to the delivery planning device 100 according to a program stored in the memory device 1003. Specifically, for example, the function of the algorithm calculation unit 130 is realized.

The interface device 1005 is used as an interface for connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs an operation result.

### Effects of Embodiment

As described above, according to the technique according to the present embodiment, it is possible to quickly create an appropriate delivery route for a vehicle to travel around a plurality of customers and replenish the inventory. Specific effects of the technique according to the embodiment include the following effects.

It is possible to create an optimal delivery route in consideration of a difference in load amount and moving speed between vehicles. In addition, it is possible to create an optimal delivery route by considering the inventory consumption speed that is different for each customer and linearly decreases, and the maximum inventory capacity for each customer.

By the vehicle selection unit 11, it is possible to accurately calculate the action timing of each agent (vehicle) and to solve the problem of the asynchronous action pattern in the multiagent problem setting.

Unlike other combinatorial optimization problems that only optimize moving costs, in the present embodiment, it is possible not only to minimize the cumulative tour costs, but also to ensure that the remaining inventory level of each customer exceeds a certain level such as 0.

Unlike the prior art that requires several days to several months to find a solution, in the present embodiment, since a robust policy is trained offline by using an advanced algorithm such as deep learning, it is possible to quickly determine solutions online for various complex situations of CIPR in a calculation time of several seconds.

Regarding the above embodiment, the following supplementary notes are further disclosed.

### <Supplementary Notes>

### (Supplement 1)

A delivery planning device including:
an algorithm calculation unit that has a model of a neural network that determines a route for a moving body on which a delivery target used for replenishment of an inventory is loaded to travel around a plurality of nodes to replenish an inventory, in which
the algorithm calculation unit inputs features of a moving body including a moving speed and a maximum load amount and features of a node including an inventory consumption speed and a maximum inventory capacity to the model.

### (Supplement 2)

The delivery planning device according to Supplement 1, in which
the model includes a moving body encoder that uses the features of the moving body as an input, a node encoder that uses the features of the node as an input, and a decoder that calculates a probability of an action of the moving body by using an output from the moving body encoder and an output from the node encoder.

### (Supplement 3)

The delivery planning device according to Supplement 1 or 2, in which
the algorithm calculation unit further includes a moving body selection unit that selects a moving body to be moved to a node as a movement destination at a next time, at a certain time.

### (Supplement 4)

The delivery planning device according to any one of Supplements 1 to 3, in which
the algorithm calculation unit includes a mask that does not select a node as a movement destination in a case where there is no time for the moving body to go to the node and return to a depot.

### (Supplement 5)

A delivery planning method performed by a delivery planning device including an algorithm calculation unit that has a model of a neural network that determines a route for a moving body on which a delivery target used for replenishment of an inventory is loaded to travel around a plurality of nodes to replenish an inventory, the delivery planning method including:
a step of, by the algorithm calculation unit, inputting features of a moving body including a moving speed and a maximum load amount and features of a node including an inventory consumption speed and a maximum inventory capacity to the model.

### (Supplement 6)

A non-transitory storage medium that stores a program for causing a computer to function as the algorithm calculation unit in the delivery planning device according to any one of Supplements 1 to 4.

Although the present embodiment has been described above, the present invention is not limited to such a specific embodiment, and various modifications and changes can be made within the scope of the gist of the present invention described in the claims.

### REFERENCE SIGNS LIST

10 Action selection unit
11 Vehicle selection unit
12 Vehicle encoder
13 Node encoder
14 Decoder
15 Mask
20 Reinforcement training unit
30 Critic unit
40 Environment holding unit
100 Delivery planning device
110 Node information collection unit
120 Delivery vehicle information collection unit
130 Algorithm calculation unit
140 Map API unit
150 Vehicle allocation unit
1000 Drive device
1001 Recording medium
1002 Auxiliary storage device
1003 Memory device
1004 CPU
1005 Interface device
1006 Display device
1007 Input device
1008 Output device

1. A delivery planning apparatus comprising:
a hardware memory storing a neural network model configured to determine a route along which at least one moving body with a delivery target used for replenishment of an inventory visits a plurality of nodes to replenish the inventory; and
circuitry configured to input, to the neural network model,
(i) one or more first features of the moving body, and
(ii) one or more second features of each of the plurality of nodes,
wherein the one or more first features include a moving speed and maximum loading capacity of the moving body, and the one or more second features include an inventory consumption rate and maximum inventory capacity of each of the plurality of nodes.

2. The delivery planning apparatus according to claim 1, wherein the neural network model includes:
a moving body encoder configured to take the first features of the moving body as input,
a node encoder configured to take the second features of each of the plurality of nodes as input, and
a decoder configured to calculate an action probability of the moving body based on an output from the moving body encoder and an output from the node encoder.

3. The delivery planning apparatus according to claim 1, wherein the at least one moving body includes a plurality of moving bodies, and
the circuitry is further configured to select a target moving body to visit a destination node at a subsequent time point from a first time point, among the plurality of moving bodies.

4. The delivery planning apparatus according to claim 1, wherein the circuitry is configured to mask a first node as a destination node, among the plurality of nodes, in a case where there is no time for the moving body to visit the first node and return to a depot.

5. A delivery planning method comprising:
inputting, to a neural network model stored in a hardware memory,
(i) one or more first features of a moving body, and
(ii) one or more second features of each of a plurality of nodes,
wherein the one or more first features include a moving speed and maximum loading capacity of the moving body, and the one or more second features include an inventory consumption rate and maximum inventory capacity of each of the plurality of nodes.

6. A non-transitory computer readable storage medium storing a program configured for causing a delivery planning apparatus to execute the delivery planning method of claim 5.
